(19) United States
(12) Patent Application Publication
(10) Pub. No.: US 2002/0095854 A1
(43) Pub. Date: Jul. 25, 2002

(54) Controlled movement fishing lure

(76) Inventor: Duane W. Kinnear, East Springfield, PA (US)

Correspondence Address: Kenneth W. Wargo, 2222 West Grandview Boulevard, Erie, PA, 16506-4508, US

(21) Appl. No.: 09/764,761

(22) Filed: Jan. 19, 2001

(51) Int. Cl. A01K 85/00

(52) U.S. Cl. 43/42.03

(57) ABSTRACT

A fishing lure whose direction of travel through the water is controllable by the fisherman as he jerks on the rod and line includes a main body having an interior activator shaft extending through the main body and terminating with an external eyelet to which the fishing line is attached. Mounted within the cavity of the main body adjacent the activator shaft is a dual position click mechanism that is engaged by the activator shaft when the fisherman jerks on the rod so that the activator shaft pivots a steering rudder plate mounted within the cavity of the main body. A steering rod is secured to the steering rudder plate and moves back and forth transversely within the main body when the steering rudder plate is pivoted whereupon the ends of the steering rod can alternately project through opposed apertures on the main body for contacting and pushing open first one and then the other steering rudder thus altering the movement and direction of travel of the lure through the water.

### BACKGROUND OF THE INVENTION

The present invention relates to fishing lures and, more particularly, relates to a fishing lure whose movement and direction of travel through the water can be controlled by the fisherman tugging or jerking on the rod and line.

Sport fishing is one of the most popular recreational activities and pastimes for men and women, young and old, amateur as well as professional. All aspects of the sport have become highly specialized, and this includes the material composition for the rods, the internal winding or spool mechanism for the reels, and the countless types of artificial lures and bait. All types of fishermen have used a wide variety of lures, and these include flies, rubber worms, spoons, spinners, plugs, and minnow-like devices. Fishermen have long known that it is highly advantageous to use lures that move or oscillate in some manner as they are drawn through the water during the process of the fisherman reeling in the fishing line. The periodic or continuous movement or oscillation of the lure through the water enhances the possibility that the lure will attract a targeted fish.

The prior art discloses a number of fishing lures that exhibit some type of movement while being drawn through the water.

For example, U.S. Pat. No. 4,581,841 to Gish discloses a fishing lure with an internal longitudinal crankshaft assembly connecting to a rear tail assembly, and an optional interior rod mechanism terminating in simulated fins along the sides of the lure. Repeated jerks or pulls on the fishing line are transmitted to the longitudinal member, and the transverse member if present, resulting in simulated tail and fin movements mimicking a swimming fish.

U.S. Pat. No. 5,080,227 to Toner et. al. discloses a frog-like lure with an internal rod, spring, and hinge mechanism that causes the legs of the lure to oscillate in a manner which mimics a swimming frog as the lure is pulled through the water by the fishing line.

U.S. Pat. No. 5,787,633 to Taylor discloses a ballistic fishing lure which features a jumping motion in which the lure can be impelled to jump out of the water by energy stored within the lure as it is dragged through the water. The jumping motion is accomplished by the action of a coil spring and a sliding tube arrangement.

Yet another type of moveable fishing lure is disclosed in U.S. Pat. Nos. 4,674,223 and 4,831,767 to Pearce. Both of these patents disclose a lure with an internal windup mechanism that is attached by a drive linkage assembly to propulsion structures, such as legs or fins that project externally from the main body of the lure. When the fishing line is pulled, energy is stored by the windup mechanism, and upon release of the line, this stored energy is released thereby causing an oscillating motion in the propulsion structures.

While the above-described fishing lures include a number of useful features, they lack the critical feature of being directionally controllable by the fisherman throughout the fishing line and lure retrieval process. Although the prior art lures provide control features that allow the user to start and stop the swimming or jumping motion of the lure, none offers the fisherman the ability to continuously control and alter movement and direction of travel during the entire retrieval process. Because the prior art provides for only straight line or random motion in fishing lure movement, there is a definite need for a lure that is selectively and continuously directionally controllable by the fisherman.

### SUMMARY OF THE INVENTION

The present invention pertains to fishing lures, and, more particularly, pertains to a fishing lure that is directionally controllable by the fisherman successively jerking on the fishing rod and line in order to vary the lateral and longitudinal movement of the fishing lure after the fishing lure has been cast and is traveling through the water during retrieval.

The fishing lure of the present invention comprehends a main body having an outer surface, an inner surface, and an interior cavity. A steering rudder is pivotally mounted to each opposite side of the outer surface of the main body, and when each steering rudder is disposed in a closed position, the steering rudders generally conform to the curvature of the main body. An activator shaft is disposed within the cavity generally coaxial with the main body and a portion of the shaft projects a small distance past the front end of the main body terminating at an eyelet to which the end of the fishing line is tied.

When the fisherman jerks the rod and line the activator shaft engages a dual position shifting mechanism that, in turn, contacts and pivots a steering rudder plate mounted within the cavity of the main body causing a steering rod secured to the steering rudder plate to slide back and forth within the cavity and transverse to the axis of the main body. The ends of the steering rod can alternately project slightly through respective apertures on the main body thereby contacting and forcing open one of the two steering rudders whereupon the force of the water striking that respective steering rudder fully opens that steering rudder thus altering the movement and direction of travel of the fishing lure through the water. A following jerk on the rod and line causes the shifting mechanism to pivot the steering rudder plate in the opposite direction so that the other end of the steering rod projects through the other aperture for contacting and forcing open the other steering rudder. Water flowing by and striking this steering rudder will force this steering rudder to the fully open position and cause the fishing lure to move and travel in a direction opposite of what it had been moving and traveling before the following jerk on the rod and line. A return spring is mounted within or without the cavity for biasing the steering rudder plate in a predetermined manner when the shifting mechanism disengages from contact with the steering rudder plate. Thus, the fisherman can vary the movement and direction of travel of the lure through the water by exerting successive jerks on the rod and line.

It is believed that the present invention provides a number of advantages over currently available lures. Previously, a fisherman located at a point A and casting his line and lure into a body of water (flowing or stationary) to point B had been restricted to retrieving his lure along a linear path denoted AB. The fisherman was able to control the return rate of the lure by varying the cranking speed of the reel; and, in some of the aforementioned prior art the fisherman could control when the lure would exhibit a swimming or jumping action. However, the general path of travel of the lure followed a straight line or perhaps an elongated curve depending upon the shape of the lure. The features of the lure of the present invention allow the user to consciously and continuously select, and then alter, the path the lure will take during retrieval. Thus, the fisherman becomes a more active participant in the process resulting in an enhancement of his or her enjoyment and success in sport fishing.

It is therefore an objective of the present invention to provide an improved fishing lure that is selectively directionally controllable by the fisherman.

It is another objective of the present invention to provide a fishing lure that is directionally controllable through simple mechanical elements that allow the lure to be inexpensively manufactured.

It is yet a further objective of the present invention to provide an improved fishing lure whose shape and form can be modified and yet still incorporate the mechanical elements necessary for permitting directional controllability.

A further objective of the present invention is to provide an improved fishing lure that does not require pre-set operations or adjustments to the fishing lure before being cast into the water to initiate variable movement through the water.

The above features, together with other objects and advantages which will become subsequently apparent, reside in the details of construction and operation as more fully hereinafter described and claimed, reference being had to the accompanying drawings, forming a part hereof, wherein like numerals refer to like parts throughout.

### BRIEF DESCRIPTION OF THE DRAWINGS

FIG. 1 is a partial cut-a-way view of the fishing lure of the present invention;

FIG. 2 is a partial cut-a-way view of the fishing lure of the present invention showing both steering rudders in the closed position;

FIG. 3 is a partial cut-a-way view of the fishing lure of the present invention showing the left steering rudder in the open position and the right steering rudder in the closed position;

FIG. 4 is a partial cut-a-way view of the fishing lure of the present invention showing the left steering rudder in the closed position, the right steering rudder in the open position, and also other internal structural elements of the lure;

FIG. 5 in an enlarged partial cut-a-way view illustrating structural elements of the lure first shown in FIG. 4;

FIG. 6 in an enlarged elevational view of the steering rudder first shown in FIG. 2 also illustrating the spring and shaft for the steering rudder;

FIG. 7 is a side elevational view of the steering rod first shown in FIG. 2; and

FIG. 8 is a top elevational view of the steering rod first shown in FIG. 2.

### DESCRIPTION OF THE PREFERRED EMBODIMENT

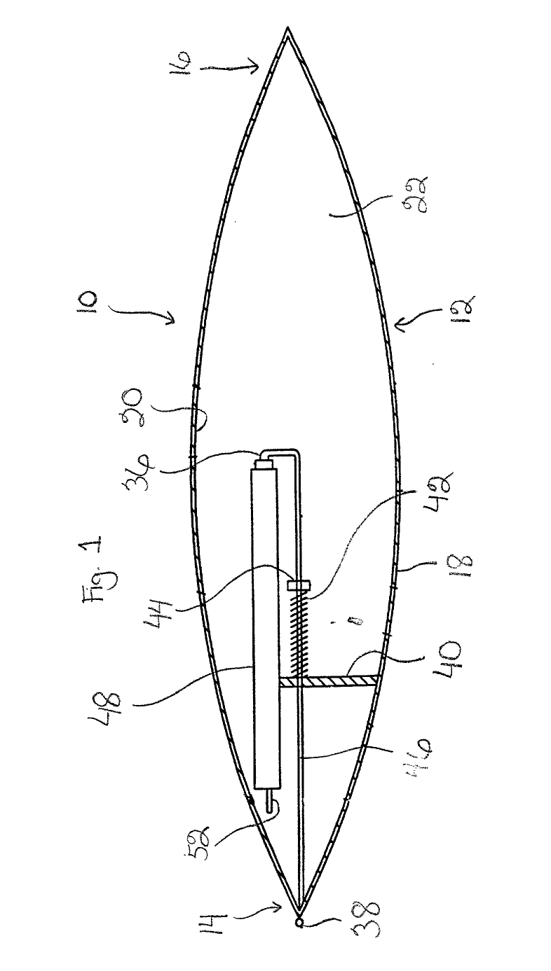

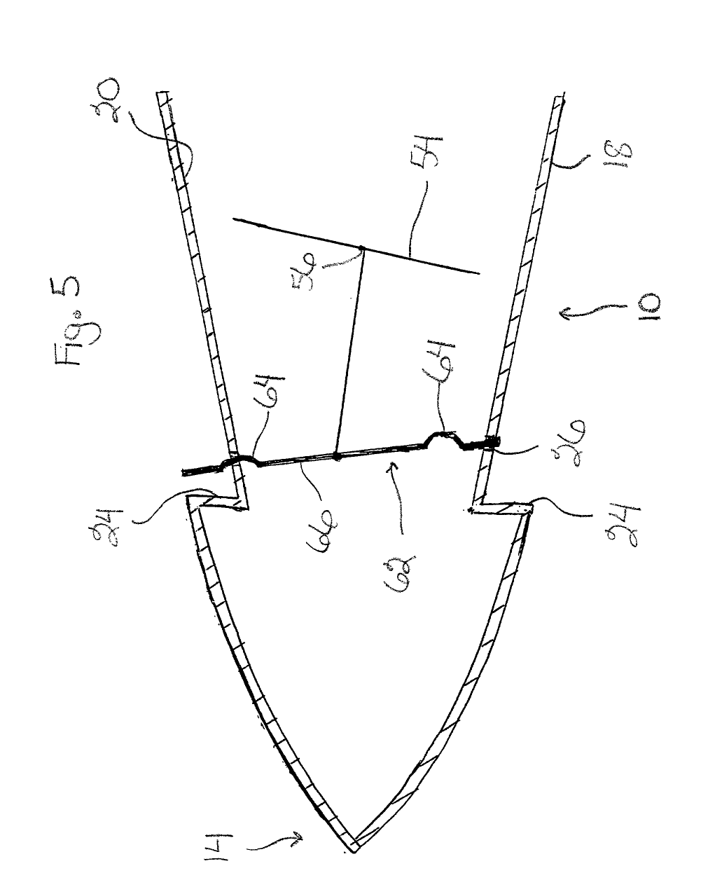

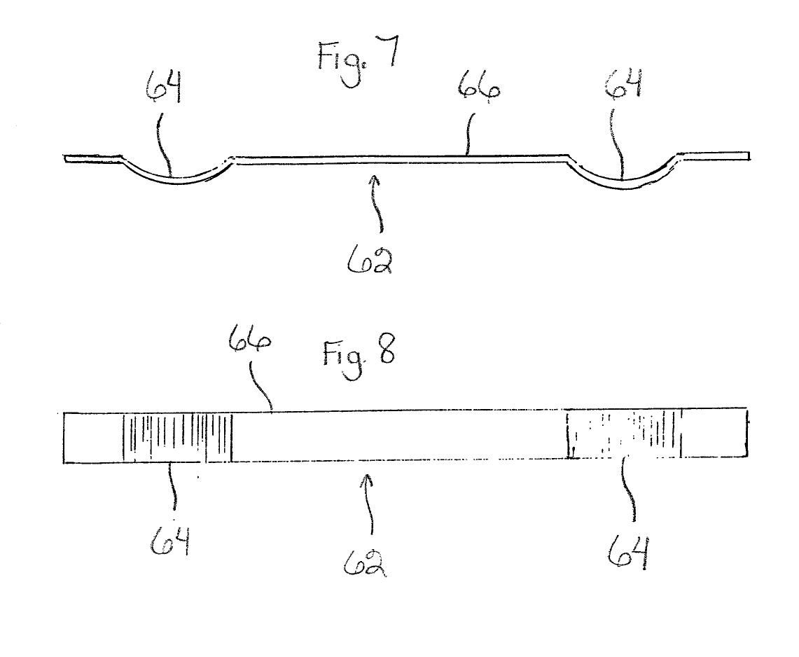

Illustrated in FIGS. 1-8 is a fishing lure 10 capable of selective controllable movement by the fisherman during and throughout the process of retrieval or reeling in of the fishing lure 10 from the body of water where the fishing lure 10 has been cast.

As shown in FIGS. 1-8, the fishing lure 10 of the present invention includes a unitary, streamlined, and tapered main body 12 aerodynamically-shaped for minimizing the resistance of the water when drawn therethrough. The main body 12 includes a front end 14, which, for purposes of orientation, will be the end pointing, or facing the fisherman after the lure has been cast into the water. The main body 12 also includes a rear end 16 which is opposite the front end 14, and would be the end pointed away from the fisherman, a generally continuous outer surface 18, and a continuous inner surface 20. The inner surface 20 defines an inner cavity or chamber 22 that extends from the front end 14 to the rear end 16; and the cavity 22 further defines a longitudinal axis that extends through the cavity 22 and both ends 14 and 16.

As shown in FIGS. 1-5, located adjacent the front end 14 is a water deflection overhang ridge or lip 24 that can extend either partially or completely about the circumference of the outer surface 18 at the area of region where the outer surface 18 starts its taper toward the front end 14. As will be more fully described hereinafter, the purpose of the water deflection lip 24 is to deflect the flow of water away from the outer surface 18 in order to lessen the interference of water movement with structural elements to be described more fully hereinafter. Positioned immediately aft of the water deflection lip 24 are a pair of oppositely disposed slots or apertures 26. To minimize and reduce the inflow of water to the cavity 22 during operation of the lure 10, each aperture 26 includes an annular watertight, preferably rubber seal 28.

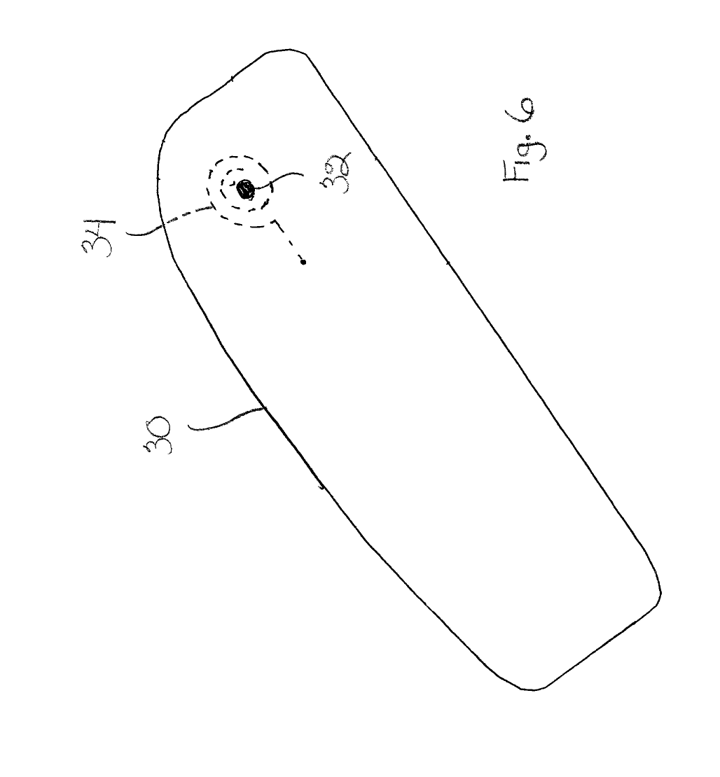

As shown in FIGS. 1-5, the fishing lure 10 includes a pair of steering flaps or rudders 30 that are pivotally mounted to the outer surface 18 of the main body 12. The steering rudders 30 are pivotally mounted to the outer surface 18 opposite to each other, and are located slightly aft of each respective aperture 26. More specifically, each steering rudder 30 is pivotally mounted to the outer surface 18 by a steering rudder shaft 32 that can be integrally formed to the outer surface 18 or secured to the outer surface 18 by lugs or ears projecting from the main body 12. When the steering rudders 30 are in the closed position, as shown in FIG. 1, the shape of each steering rudder 30 allows them to generally conform to the overall curvature of the outer surface 18 of main body 12. In order to bias the steering rudders 30 to the closed position when the lure 10 is stationary or stopped in the water and not in the process of being reeled in, a steering rudder closure spring 34 is mounted on each respective shaft 32 as illustrated in FIG. 6. Each spring 34 exerts a torsion force on each respective steering rudder 30 tending to bias each steering rudder 30 to the closed position. However, this torsion force is overcome by the flow of water rushing along the main body 10 from the front end 14 to the rear end 16 as the lure 10 is being reeled in, thus keeping the steering rudders 30 in the open position as will be more fully described hereinafter.

As shown in FIG. 1, the fishing lure 10 includes an activator shaft 36 that is mounted within the chamber 22 coaxial with the longitudinal axis that is defined by the chamber 22. The extension of the activator shaft 36 may be half the length of the chamber 22, and a small portion of the shaft 36 will extend outwardly past the first end 14 and terminate at an eyelet 38 to which the end of the fishing line (not shown) can be tied. An activator shaft support stem or plate 40 is mounted to the inner surface 20 and projects within the chamber 22 perpendicular to the axis of the chamber 22 for supporting the shaft 36. The support plate 40 includes an aperture (not shown) through which the activator shaft 36 can pass, and the plate 40 and aperture function somewhat like a bushing for supporting and guiding the linear reciprocable movement of the activator shaft 36 within the chamber 22 and coaxial therewith. Mounted to a portion of the shaft 36 immediately rearward of support plate 40 is an activator shaft return spring 42. The return spring 42 is disposed between, and has both of its ends compressed by, the support plate 40 and a stop block 44 which is mounted on the shaft and travels with the shaft 40. Furthermore, as shown in FIG. 1, the activator shaft 36 includes a generally unshaped interior end 46 integrally formed with the shaft 40 and which travels concomitant with the reciprocable movement of the shaft 40.

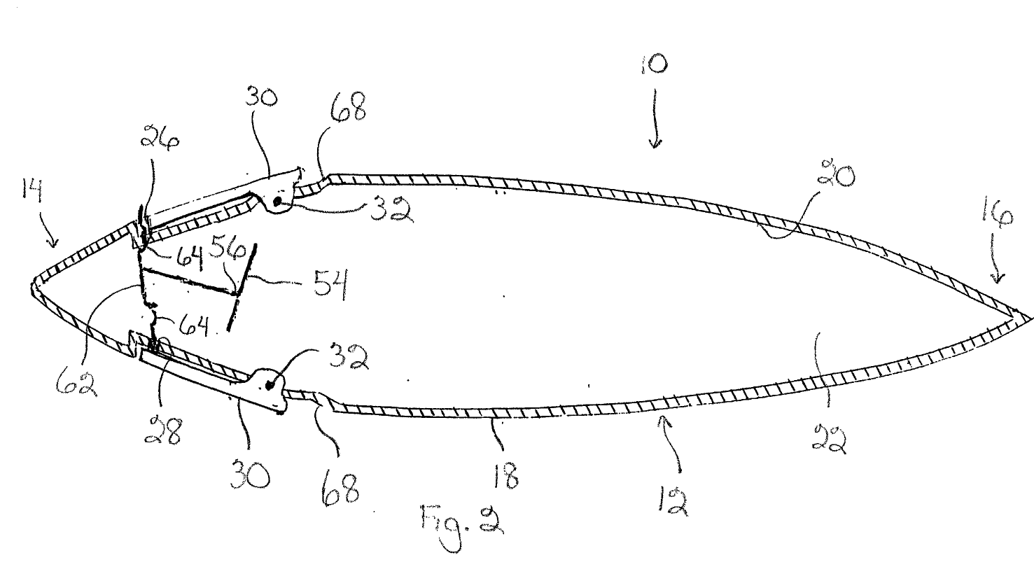

Illustrated in FIGS. 1-2, and with reference to U.S. Pat. No. 6,122,854, the selective linear reciprocable movement of the shaft 36 which results from the fisherman pulling or jerking on the rod and line causes the interior end 46 of the shaft 36 to contact elements of a dual position click mechanism 48 that is fully described in U.S. Pat. No. 6,122,854 and incorporated herein by reference. The click mechanism 48 is mounted within the chamber 22 by supporting bars or struts 50 that project into the chamber 22 and which are secured to the inner surface 20 of the main body 12. The click mechanism 48 includes a stem 52 that projects externally from the click mechanism adjacent the front end 14 of the main body 12. The stem 52 is capable of selective linear reciprocable movement coaxial with the click mechanism 48 when the stem 52 is engaged by structural elements contained within the click mechanism 48 and more fully described in U.S. Pat. No. 6,122,854.

Illustrated in FIGS. 2-5, is a means to selectively open and close the steering rudders 30 in order to change or alter the movement or direction of travel of the lure 10 through the water during the process of retrieving the lure 10 by the fisherman. The means to selectively open and close each steering rudder 30 by jerking or pulling on the rod and line includes a t-shaped steering rudder plate 54 pivotally mounted to the inner surface 20 by a shaft 56, such as a pin or rod, that extends at least partially into the chamber 22. The steering rudder plate 54 is positioned within the chamber 22 so that only one leg of the rudder plate 54 contacts the stem 52 of the click mechanism 50. The other leg of the rudder plate 54 is engaged by a return spring 58 that is mounted to a return spring support base 60 that extends into the chamber 22 from its securement to the inner surface 20 of the main body 12. The alternating engagement of the stem 52 and the return spring 58 against the respective legs of the t-shaped rudder plate 54 facilitates the pivotal motion of the plate 54 on the shaft 56 between a first position and a second position, and these two positions correspond to a leftward and a rightward pivotal action with reference to the front end 14 of the lure 10.

As shown in FIGS. 2-5, and 7 and 8, an elongated steering rod 62 is disposed within the chamber 22 and is positioned therein for linear, reciprocable, slidable movement transverse to the axis of the chamber 22. The steering rod 62 is pivotally attached to the steering rudder plate 54 and slides back and forth within the chamber 22 as a result of the pivotal movement of the steering rudder plate 54. The steering rod includes two oppositely disposed cambered portions 64 interconnected by a flat middle section 66, and each cambered portion 66 terminates with a flat projecting end that is parallel with the flat middle section 66. The steering rod 62 is pivotally mounted to the steering rudder plate 54 so that the cambered portions 64 are aligned with the apertures 26 on the main body 12, whereupon as the steering rudder plate 54 pivots on shaft 56 first one cambered portion 64, and then the other cambered portion 64, will slide partially through and catch on the respective apertures 26 thus assisting in holding the steering rod 62 in that position after the steering rod 62 has been pivoted.

In operation the fisherman would fix some type of bait to hooks attached to the lure 10, as described in U.S. Pat. No. 6,122,854, and then the fisherman would cast the line and lure 10 into the water. The action of casting the lure 10 into the water and the initial setting of the line and bait will generally cause one of the two steering rudders 30 to shift or move to an open position. It would by highly unlikely, though not strictly impossible, for the lure 10 to hit the water and have both steering rudders 30 stay in the closed position. Therefore, there is no initial or starting position for the steering rudders 30, the pivot plate 54, or the steering rod 62.

In the following description of the operation of the lure 10, the lateral movement of the lure 10 to the left and right will be oriented with reference to the front end 14 of the lure 10 as it points toward the fisherman so that left and right will be with respect to the lure 10 and not the fisherman. By successively jerking or pulling on the line, the fisherman can continuously alter the path, direction of travel, and lateral movement of the lure 10 as the lure 10 moves through the water. When retrieval of the line is stopped or sufficiently slowed, the lure 10 will go to the straight retrieve position as shown in FIG. 2, wherein the force of the water flowing past both (previously open) steering rudders 30 will have lessened thereby allowing springs 34 to overcome the force of the ambient water and bias the steering rudders 30 to the closed position.

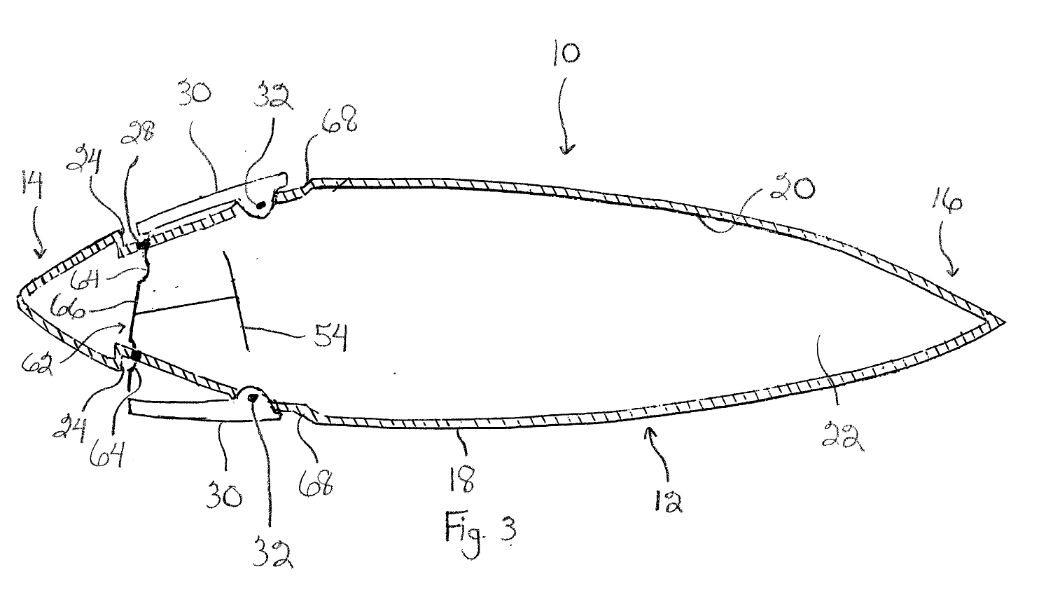

In FIG. 3 the fisherman has jerked or pulled on the rod and line initiating actions in the lure 10 for producing a leftward movement or direction of travel. The steering rudder plate 54 has pivoted to the left causing the steering rod 62 to slide leftward thereby causing the leftmost projecting end of the rod 62, and the cambered portion 64, to slide through the aperture 26 (the left aperture) contacting and forcing the left steering rudder 30 open. Simultaneous with the leftmost projecting end of the rod 62 pushing against the rudder 30, the cambered portion 64 will slide partly through the aperture 26, and this movement causes the projecting end of the rod 62 to move slightly forward of the steering rudder 30. Thus, after opening the steering rudder 30 the left projecting end of the rod 62 will be positioned slightly ahead of the rudder 30 for allowing the rudder 30 to close unimpeded if the forward motion of the lure 10 (in the direction toward the fisherman) is suddenly halted.

Although both steering rudders 30 include biasing springs 34 for closing the rudders 30 when retrieval of the lure 10 is stopped, the force of the water flowing against the steering rudders 30 when the lure 10 is traveling in the water will overcome the force of the springs 34 and maintain each respective rudder 30, in turn, in the open position. The biasing springs 34 can be selected to have sufficient torsion to achieve a desirable point at which the pressure from the springs 34 is sufficient to overcome the force of the water and close the rudders 30. For instance, stronger springs 34 may be used if the goal is to close the rudders 30 even at a slow rewind, while weaker springs 34 would be used if the aim is to close the rudders 30 only when the rewind is completely stopped.

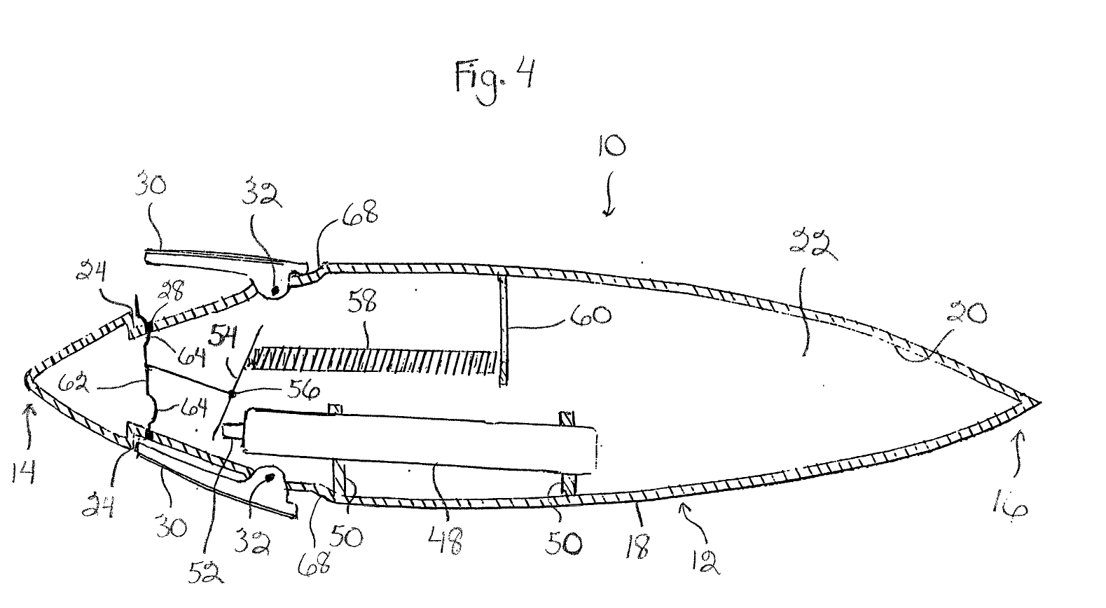

The pivotal motion of each steering rudder 30 is limited by indentations 68 formed on the main body 12 slightly aft of the location where each shaft 32 is mounted to the main body 10. Should the fisherman desire to alter or change the movement or direction of travel of the lure 10, he or she would again jerk or pull on the rod and line. This action causes the extension of the stem 52 whereupon the return spring 58 will contract due to the force of the pivotal movement of the other leg of the steering rudder plate 54 against the spring 58. All of the above-described actions would then occur but with the final result of opening the steering rudder 30 on the right side of the lure 10, as shown in FIG. 4, and thus altering or changing the movement or direction of travel of the lure 10 to the right.

The foregoing is considered as illustrative only of the principles of the invention. Since numerous modifications and changes will readily occur to those skilled in the art, it is not desired to limit the invention to the construction shown and described. Accordingly, all suitable modifications and equivalents may be resorted to falling within the scope of the invention.

The foregoing is considered as illustrative only of the principles of the invention: Since numerous modifications and changes will readily occur to those skilled in the art, it is not desired to limit the invention to the construction shown and described. Accordingly, all suitable modifications and equivalents may be resorted to falling within the scope of the invention.

What is claimed is:

1. A fishing lure whose movement and direction of travel in the water is controllable, comprising:
an elongated main body having an interior chamber and a pair of oppositely disposed apertures;
a steering rudder plate disposed within the chamber for selective pivotal movement between a first position and a second position;
a steering rod attached to the steering rudder plate for selective linear reciprocable movement within the cavity as a result of the pivotal motion of the steering rudder plate; and;
a pair of steering rudders with steering rudder mounted to the main body adjacent each respective aperture for selective pivotal movement between a closed position and an open position when contacted by one end of the steering rod projecting through one of the apertures in order to alter the movement and direction of travel of the lure through the water.

2. The fishing lure of claim 1 wherein the main body includes a front end, an opposite rear end, a continuous outer surface and an inner surface.

3. The fishing lure of claim 2 wherein the main body defines a longitudinal axis that extends through the chamber from the front end to the rear end.

4. The fishing lure of claim 3 wherein the main body includes a circumferential lip integrally formed on the outer surface adjacent the front end and forward of the steering rudders.

5. The fishing lure of claim 4 wherein the steering rod includes a flat middle section and opposed cambered portions and each cambered portion partially slidable through each respective aperture for pushing the steering rudders to the open position.

6. A fishing lure whose direction of travel through the water is controllable by the fisherman jerking on the rod and line, comprising:
a main body having a front end, an opposite rear end, and an interior chamber extending from the front end to the rear end;
the main body having a pair of oppositely disposed apertures adjacent the front end;
a pair of steering rudders with each steering rudder pivotally mounted to the main body adjacent each respective aperture for selective movement between a closed position and an open position in order to alter the direction of travel of the lure through the water;
a steering rudder plate disposed within the chamber for selective pivotal motion between a first position and a second position;
a steering rod attached to the steering rudder plate for reciprocable movement within the chamber when the steering rudder plate pivots so that one end of the steering rod can project through one aperture in order to engage and push open that steering rudder; and
a dual position click mechanism disposed within the chamber and which is actuated when the fisherman jerks on the rod and line so that the dual position click mechanism can contact and pivot the steering rudder plate whereupon the pivotal motion of the steering rudder plate causes the slidable movement of the steering rod for contacting and opening each steering rudder.

7. The fishing lure of claim 6 wherein the main body includes a lip extending about the main body adjacent the apertures for preventing the flow of water from around the main body from inadvertently opening either of the steering rudders.

8. The fishing lure of claim 7 wherein the steering rudder plate is t-shaped and pivots on a shaft disposed within the chamber.

9. The fishing lure of claim 8 wherein the steering rod includes a flat middle section and opposed cambered portions that can partially project through each respective aperture for opening each steering rudder as the steering rod slides back and forth within the chamber as a result of the pivotal motion of the steering rudder plate.

10. The fishing lure of claim 9 wherein the steering rudders may both be pivoted to the closed position, the open position, and one steering rudder may be pivoted to the closed position while the other steering rudder may be pivoted to the open position.
